(19) United States
(12) Patent Application Publication
(10) Pub. No.: US 2025/0391145 A1
(43) Pub. Date: Dec. 25, 2025

(54) IMAGE PROCESSING METHOD AND APPARATUS, DEVICE, MEDIUM, AND PRODUCT

(71) Applicant: Shanxi University, Taiyuan City (CN)

(72) Inventors: Jizhou WU, Taiyuan City (CN); Jie MA, Taiyuan City (CN); Jun JIAN, Taiyuan City (CN); Wenliang LIU, Taiyuan City (CN)

(21) Appl. No.: 19/021,756

(22) Filed: Jan. 15, 2025

(30) Foreign Application Priority Data
Jun. 19, 2024 (CN) 202410788789.5

(51) Int. Cl. G06V 10/25; G06T 5/50; G06V 20/70

(52) U.S. Cl. CPC G06V 10/25; G06T 5/50; G06V 20/70; G06T 2207/20081; G06T 2207/20221

(57) ABSTRACT

Provided are an image processing method and apparatus, a device, a medium, and a product, and relates to the field of image processing. The image processing method includes: acquiring atomic samples in Bose-Einstein condensate, and obtaining experimental images with absorption imaging; preprocessing the experimental images, and labeling a color picture obtained by the preprocessing to generate a training sample set; training a YOLOv5s network with the training sample set, and taking a well-trained network as an atomic cloud region localization network; inputting experimental images of to-be-tested atoms to the atomic cloud region localization network to obtain an atomic cloud region localization result; and refining the atomic cloud region localization result with grid search, performing Gaussian fitting on each grid to obtain a goodness-of-fit, and selecting an atomic parameter corresponding to a grid having a highest goodness-of-fit as a final fitting result.

### CROSS REFERENCE TO RELATED APPLICATION

This patent application claims the benefit and priority of Chinese Patent Application No. 202410788789.5, filed with the China National Intellectual Property Administration on Jun. 19, 2024, the disclosure of which is incorporated by reference herein in its entirety as part of the present application.

### TECHNICAL FIELD

The present disclosure relates to the field of image processing, and in particular to an image processing method and apparatus, a device, a medium, and a product.

### BACKGROUND

As an excellent macroscopic quantum system, the Bose-Einstein condensation (BEC) has provided a key experimental platform for advancements of quantum simulation, quantum computing, and quantum security communication since its discovery and experimental realization. This greatly promotes the development of quantum science. When the BEC experiment is conducted, the absorption imaging is a widely employed technique for acquiring information of an atomic cloud. Specifically, the laser beam resonant with atomic absorption lines is used to irradiate a to-be-tested atomic cloud. Photons are absorbed by irradiated atoms. The charge coupled device (CCD) camera is used to capture a laser distribution image after the photons are absorbed by the atoms. With computation and quantitative analysis on the image, a visible spatial distribution of ultra-cold atoms, and other important physical information of the atomic cloud, such as the temperature, the phase space density and the dynamic behavior, can be obtained. Hence, data acquired from the absorption imaging is of importance to further development of the ultracold atom experiment.

In spite of strong practicability, the absorption imaging is still improved continuously for some physical constraints. For example, the partial-transfer absorption imaging can sample the same cloud repeatedly with minimal interference. The Ramsey interferometry with quantum coherence can accurately calibrate the intensity of probe light in the absorption imaging system. While measuring the atomic density more accurately, the Ramsey interferometry directly calibrates the loss of the imaging system and the quantum efficiency of the sensor. Thanks to these advancements, the absorption imaging is improved greatly to extract more physical information from the ultracold atoms. However, the improvements focus mainly on optimization of experimental devices and imaging principles, but rarely on effective and accurate extraction of information from the absorption imaging.

To acquire accurate physical information from the absorption image, it is crucial to accurately identify a region of the atomic cloud. The conventional method for extracting the information of the atomic cloud mainly depends on direct Gaussian fitting. The method is not accurate enough to identify the region of the atomic cloud and has the limited generalization capability to identify features of the atomic cloud. In case of a plurality of atomic clouds in the single image, the region of each cloud is to be identified manually for Gaussian fitting, or information of the atomic cloud is extracted with multi-peak Gaussian fitting. However, the accuracy of the multi-peak Gaussian fitting largely depends on selection of initial parameters, atomic cloud distribution and background noise. To quickly and accurately extract physical information from the image, all of the above methods are certainly restricted.

Particularly, when the spinor BEC is used in the quantum control experiment, it is crucial to accurately acquire positions, sizes and atomic numbers of three spin components. The conventional image processing methods have long time consumption and inaccuracy, which hinders advancements of the quantum simulation, topological research, and precision measurement using the spinor BEC.

### SUMMARY

An objective of the present disclosure is to provide an image processing method and apparatus, a device, a medium, and a product. The present disclosure can improve efficiency and accuracy of the atomic cloud localization in the image and effectively solves problems of long time consumption and inaccuracy of the conventional image processing method.

To achieve the above objective, the present disclosure provides the following technical solutions:

According to a first aspect, the present disclosure provides an image processing method, including:
acquiring atomic samples in Bose-Einstein condensate, and obtaining experimental images with absorption imaging;
preprocessing the experimental images to obtain a color picture, the color picture including an atomic cloud of the atomic samples;
labeling the color picture to generate a training sample set;
training a YOLOv5s network with the training sample set to obtain a well-trained YOLOv5s network, and taking the well-trained YOLOv5s network as an atomic cloud region localization network;
inputting experimental images of to-be-tested atoms to the atomic cloud region localization network to obtain an atomic cloud region localization result of the to-be-tested atoms; and
refining the atomic cloud region localization result with grid search, performing Gaussian fitting on each grid to obtain a goodness-of-fit, and selecting an atomic parameter corresponding to a grid having a highest goodness-of-fit as a final fitting result.

Optionally, the acquiring atomic samples in Bose-Einstein condensate, and obtaining experimental images with absorption imaging specifically includes:
in a process of acquiring the atomic samples in Bose-Einstein condensate, performing imaging for three times according to a principle of the absorption imaging to obtain a first image, a second image, and a third image, and taking the first image, the second image, and the third image as the experimental images, where the first image is used for displaying an intensity distribution of the atomic cloud under irradiation of probe light, the second image is an image captured when there is only the probe light without atoms; and the third image is used for displaying a background intensity when there is neither the probe light nor the atoms.

Optionally, the preprocessing the experimental images to obtain a color picture specifically includes:
overlapping the first image, the second image, and the third image to obtain an initial color picture;
determining optical densities of the atomic samples in three imaging processes, and performing thresholding and normalization on the optical densities to obtain the atomic cloud; and
displaying the atomic cloud correspondingly in the initial color picture to obtain the color picture.

Optionally, the labeling of the color picture to generate a training sample set specifically includes:
labeling a regional location of the atomic cloud in the color picture with a rectangular region to obtain labeled sample data; and
generating the training sample set based on the labeled sample data.

According to a second aspect, the present disclosure provides an image processing apparatus, which is applied to atoms in Bose-Einstein condensate, and includes: a science cavity, radio-frequency (RF) coils, a CCD camera, and a personal computer (PC) terminal, where
the science cavity is configured to acquire the atoms in Bose-Einstein condensate; the RF coils are respectively provided at two opposite optical inlets of the science cavity; the RF coil is configured to transmit an RF signal of a specified frequency, so as to control the atoms; the CCD camera is connected to the PC terminal; the CCD camera is configured to acquire experimental images of the atoms; and the PC terminal is configured to realize the image processing method, so as to obtain an atomic cloud region localization result based on the experimental images.

Optionally, a main body of the science cavity is an octagonal metal cavity; three pairs of optical inlets are provided in a first direction of the octagonal metal cavity; a pair of optical inlets are provided in a second direction of the octagonal metal cavity; the first direction is perpendicular to the second direction; the optical inlet is covered by a window; and in the three pairs of optical inlets in the first direction, a collimator and a λ/4 wave plate are provided sequentially along an optical transmission direction of each optical inlet.

Optionally, the image processing apparatus further includes a titanium sublimation pump and an ionic pump; and both the titanium sublimation pump and the ionic pump are configured to keep a vacuum environment of the science cavity.

According to a third aspect, the present disclosure provides a computer device, including a memory, a processor, and a computer program stored in the memory and executable on the processor, where the processor is configured to execute the computer program to realize steps of the above image processing method.

According to a fourth aspect, the present disclosure provides a computer-readable storage medium, where the computer-readable storage medium stores a computer program, and the computer program is executed by a processor to realize steps of the above image processing method.

According to a fifth aspect, the present disclosure provides a computer program product, including a computer program, where the computer program is executed by a processor to realize steps of the above image processing method.

According to specific examples provided in the present disclosure, the present disclosure discloses the following technical effects:

According to the image processing method and apparatus, the device, the medium, and the product provided by the present disclosure, by acquiring the atomic samples in Bose-Einstein condensate, the present disclosure can obtain the experimental images with the absorption imaging. By preprocessing the experimental images to form the color picture, the present disclosure makes positions of the atoms more visualized. By performing model training on the obtained color picture to obtain the network model capable of automatically realizing atomic cloud region localization, the present disclosure can improve efficiency and accuracy of the atomic cloud localization in the image and effectively solves problems of long time consumption and inaccuracy of the conventional image processing method.

### BRIEF DESCRIPTION OF THE DRAWINGS

To describe the technical solutions in the embodiments of the present disclosure or in the prior art more clearly, the following briefly describes the accompanying drawings required for the embodiments. Accordingly, the accompanying drawings in the following description show merely some embodiments of the present disclosure, and a person of ordinary skill in the art may still derive other accompanying drawings from these accompanying drawings without creative efforts.

In the accompanying drawings, reference characters refer to the same parts throughout the different views. The drawings are not necessarily to scale; emphasis has instead been placed upon illustrating the principles of the invention. Of the drawings:

FIG. 1 illustrates an application environment of an image processing method according to an embodiment of the present disclosure;

FIG. 2 is a schematic flowchart of an image processing method according to an embodiment of the present disclosure;

FIG. 3 is an implementation architecture of an image processing apparatus according to an embodiment of the present disclosure;

FIG. 4 is a schematic view of a network training process according to an embodiment of the present disclosure; and

FIG. 5 is a schematic structural view of a computer device according to an embodiment of the present disclosure.

### DETAILED DESCRIPTION OF THE EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easier to understand, the present disclosure will be further described in detail with reference to the accompanying drawings and specific implementations.

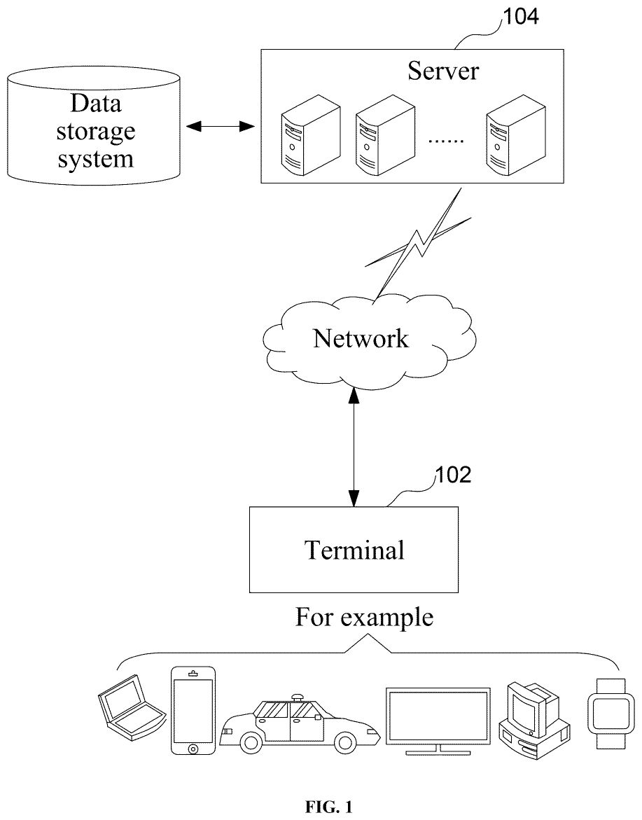

The image processing method provided in the embodiment of the present disclosure may be applied to an application environment shown in FIG. 1. The terminal 102 communicates with the server 104 through a network. The data storage system may store data to be processed by the server 104. The data storage system may be provided individually, may also be integrated onto the server 104, and may also be provided on a cloud or other servers. The terminal 102 may send an experimental BEC image of to-be-localized atoms to the server 104. After the server 104 receives the experimental BEC image, the server 104 inputs the experimental BEC image to an atomic cloud region localization network to obtain an atomic cloud region localization result of the to-be-localized atoms. The server refines the atomic cloud region localization result with grid search, performs Gaussian fitting on each grid to obtain a goodness-of-fit, and selects an atomic parameter corresponding to a grid having a highest goodness-of-fit as a final fitting result. The server 104 may feed the final fitting result back to the terminal 102. In addition, in some embodiments, the image processing method may also be realized by the server 104 or the terminal 102 individually. For example, the terminal 102 may directly obtain the final fitting result for the experimental BEC image of the to-be-localized atoms. The server 104 may also acquire the experimental BEC image of the to-be-localized atoms from the data storage system, and obtain the final fitting result for the experimental BEC image of the to-be-localized atoms.

The terminal 102 may be, but is not limited to, various desktop computers, notebook computers, smartphones, tablet computers, Internet of things (IoT) devices and portable wearable devices. The IoT devices may be smart speakers, smart televisions, smart air conditioners, smart vehicle-mounted devices, etc. The portable wearable devices may be smartwatches, smart bracelets, headset devices, etc. The server 104 may be a standalone server or a server cluster consisting of a plurality of servers, and may also be a cloud server.

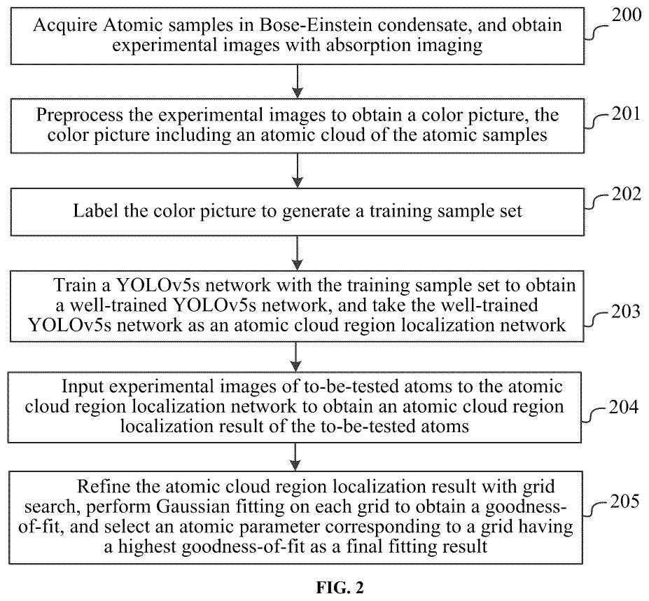

In an exemplary embodiment, as shown in FIG. 2, an image processing method is provided. The method is executed by a computer device. Specifically, the method may be individually executed by the computer device such as the terminal or the server, and may also be collectively executed by the terminal and the server. In the embodiment of the present disclosure, with the method applied to the server 104 in FIG. 1 as an example, the method includes the following steps 200-205.

Step 200: Atomic samples in Bose-Einstein condensate are acquired, and experimental images are obtained with absorption imaging.

Step 201: The experimental images are preprocessed to obtain a color picture. The color picture includes an atomic cloud of the atomic samples.

Step 202: The color picture is labeled to generate a training sample set.

Step 203: A YOLOv5s network is trained with the training sample set to obtain a well-trained YOLOv5s network, and the well-trained YOLOv5s network is taken as an atomic cloud region localization network.

Step 204: Experimental images of to-be-tested atoms are input to the atomic cloud region localization network to obtain an atomic cloud region localization result of the to-be-tested atoms.

Step 205: The atomic cloud region localization result is refined with grid search, Gaussian fitting is performed on each grid to obtain a goodness-of-fit, and an atomic parameter corresponding to a grid having a highest goodness-of-fit is selected as a final fitting result.

By implementing the step 200 to the step 205, the present disclosure can improve efficiency and accuracy of the atomic cloud localization in the image, and effectively solves problems of long time consumption and inaccuracy of the conventional image processing method. Meanwhile, by preprocessing the experimental images to obtain the color picture, the present disclosure can make positions of the atoms more visualized. In addition, in view of requirements on a clear atomic image and a uniform background, the present disclosure selects the YOLOv5s as a basic pre-training model to obtain the best balance between the computational efficiency and the accuracy.

In another exemplary embodiment of the present disclosure, in order to acquire a large number of atomic samples in an ultra-high vacuum system, the step 200 may be substituted by the following steps:

In a process of acquiring the atomic samples in Bose-Einstein condensate, imaging is performed for three times according to a principle of the absorption imaging to obtain a first image, a second image, and a third image, and the first image, the second image, and the third image are taken as the experimental images. The first image is used for displaying an intensity distribution of the atomic cloud under irradiation of probe light, the second image is an image captured by an image pick-up device (such as a CCD camera) when there is only the probe light without atoms; and the third image is used for displaying a background intensity when there is neither the probe light nor the atom.

In actual application, in order to acquire the large number of atomic samples in the ultra-high vacuum system, the atomic beam is pre-cooled with a Zeeman slower first, and then loaded to a magneto-optical system. Parameters such as a laser intensity, a laser detuning parameter, and a magnetic field intensity are adjusted to realize a compressive magneto-optical trap, optical molasses and the like, thereby increasing a density of an atomic cloud, and reducing a temperature of the atomic cloud. Thereafter, atoms are transferred to a pair of crossed dipole traps for evaporative cooling, thereby realizing the BEC.

In another exemplary embodiment of the present disclosure, in view that the obtained experimental images are independent and gray, and the positions of the atoms are hardly distinguished by naked eyes, the step 201 may be substituted by the following steps:

(1) The first image, the second image, and the third image are overlapped to obtain an initial color picture, so as to make the positions of the atoms more visualized.

(2) Optical densities of the atomic samples are determined in three imaging processes, and thresholding and normalization are performed on the optical densities to obtain the atomic cloud. The optical density is expressed as OD:

$$OD ( x , y ) = - ln \frac{I ( x , y ) - {I}_{bg} ( x , y )}{{I}_{0} ( x , y ) - {I}_{bg} ( x , y )} ,$$

where, I(x, y) is a light intensity of an absorption image in which the atomic cloud is distributed under the irradiation of the probe light, I_{bg}(x, y) is an intensity of background noise when there is neither the probe light nor the atoms, and I₀(x, y) is a light intensity when there is only the probe light without the atoms.

(3) The atomic cloud is displayed correspondingly in the initial color picture to obtain the color picture containing information of the atomic cloud.

In another exemplary embodiment of the present disclosure, in order to make labeled data more accurate, the step 202 may be substituted by the following steps:

(1) A regional location of the atomic cloud in the color picture is labeled with a rectangular region to obtain labeled sample data. This may be realized automatically by the computer, and may also be realized manually. A central position or a size of the rectangular region may be determined according to actual information of the atomic cloud.

(2) The training sample set is generated based on the labeled sample data.

In another exemplary embodiment of the present disclosure, in order to obtain the most accurate and most representative atomic parameter from analysis, the step 205 may be substituted by the following steps:

In the grid search, with a central point of the predicted rectangular box as a reference, and a length of a long side of the rectangular box as a grid size, a square grid is constructed. The search is performed in a range of 60% to 150% of the long side, and at a stride of two pixels. The Gaussian fitting is performed on each grid to compute a goodness-of-fit. An atomic parameter corresponding to a grid having a highest goodness-of-fit is selected as a final fitting result.

In an exemplary embodiment, descriptions are made through experimental validation on superiority of the image processing method provided by the present disclosure. Specifically:

A: A BEC of sodium (Na) atoms is realized in a science cavity system. In order to collect a large number of Na atomic samples in the ultra-high vacuum system, the Na atomic beam is pre-cooled with a Zeeman slower first, and then loaded to a magneto-optical system. Parameters such as a laser intensity, a laser detuning parameter, and a magnetic field intensity are adjusted to realize a compressive magneto-optical trap, optical molasses and the like, thereby increasing a density of an atomic cloud, and reducing a temperature of the atomic cloud. Thereafter, atoms are transferred to a pair of crossed dipole traps for evaporative cooling, thereby realizing the BEC.

B: The atomic cloud is visualized with absorption imaging, and experimental images are acquired. In this step, according to a principle of the absorption imaging, images of the atomic cloud captured in the three-dimensional (3D) magneto-optical trap are acquired with a CCD camera. The images of the atomic cloud are preprocessed to generate a color picture containing information of the atomic cloud.

C: A training set is constructed. A regional location of the atomic cloud is labeled with a central coordinate and a size of a rectangle. For example, the region of the atomic cloud is labeled by manually drawing the rectangle.

D: Model training is performed. In this step, in view of requirements on a clear atomic image and a uniform background, a YOLOv5s is selected as a basic pre-training model to obtain the best balance between the computational efficiency and the accuracy.

E: A training result is evaluated. In this step, in order to validate the accuracy of the evaluated result, evaluation indexes, such as an accurate rate, a recall rate, and an F1 score, are used to evaluate performance of the model.

F: The position of the atomic cloud is refined with grid search. In this step, the goodness-of-fit in the grid search is used as a standard to determine a best region.

G: Correctness of the model is validated with experimental data. In this step, the model is validated with levels mf=−1 and mf=0 of RF-coupled Na atoms F=1, and experimental data of Rabi oscillation in the two-level system. F represents a quantum number in the atomic hyperfine structure, and mf represents a magnetic quantum number of the split level.

In view of this, with advantages of deep learning in object detection tasks, and with the YOLOv5 model for calibrating the region of the atomic cloud in the picture in the absorption imaging, the present disclosure effectively solves the problems of long time consumption and inaccuracy of the conventional image processing method, and is applied to processing experimental data of ultracold atoms based on the absorption imaging.

Based on a same inventive concept, an embodiment of the present disclosure further provides an image processing apparatus for realizing the image processing method. Implementation solutions provided by the apparatus for solving the problems are the same as those provided by the method. Specific limitations in one or more of the following embodiments of the image processing apparatus may refer to the limitations on the image processing method, and are not repeated herein.

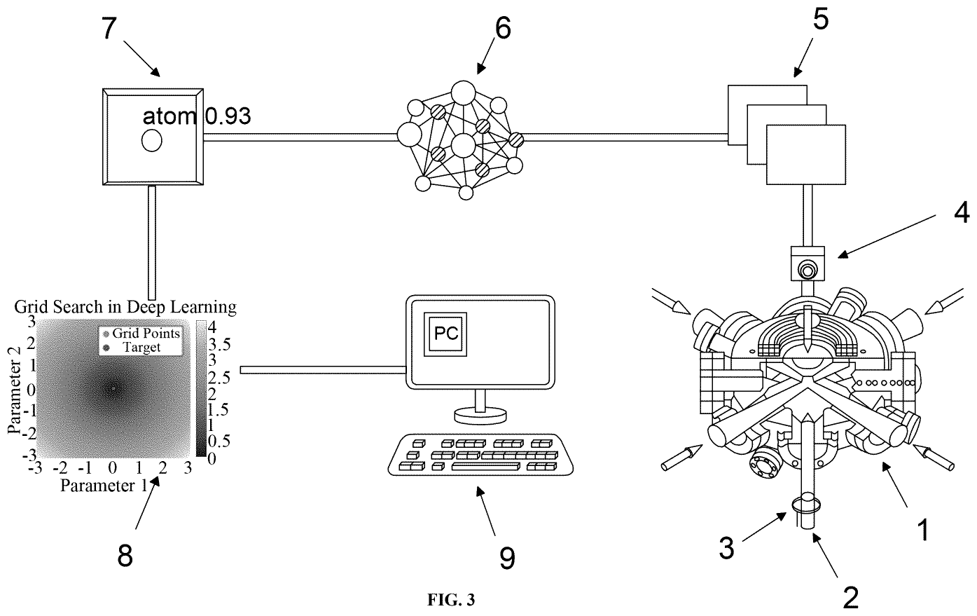

In an exemplary embodiment, as shown in FIG. 3, an image processing apparatus is provided, including: a science cavity, RF coils, a CCD camera, and a PC terminal.

The science cavity is configured to acquire atoms in Bose-Einstein condensate. A formed Na BEC is located at a central position of the science cavity. The RF coils are respectively provided at two opposite optical inlets of the science cavity. The RF coil is configured to transmit an RF signal of a specified frequency, so as to control the atoms. The CCD camera is connected to the PC terminal. The CCD camera is configured to acquire experimental images of the atoms. The PC terminal is configured to receive images from the CCD camera, and realize image processing, labeling on a region of an atomic cloud, model training and application. That is, the PC terminal is configured to realize the image processing method provided by the present disclosure, so as to obtain a final fitting result based on the experimental images.

In FIG. 3, the numeral 1 corresponds to the science cavity, the numeral 2 corresponds to imaging light, the numeral 3 corresponds to the RF coil, the numeral 4 corresponds to the CCD camera, the numeral 5 corresponds to the experimental image, the numeral 6 corresponds to a preliminary atomic cloud region localization network, the numeral 7 corresponds to the grid search process, the numeral 8 corresponds to the final fitting result, and the numeral 9 corresponds to the PC terminal.

As an optional implementation, the CCD camera may be a Guppy pro CCD with a pixel size of 3.7 μm.

As an optional implementation, a main body of the science cavity is an octagonal metal cavity. Three pairs of optical inlets are provided in a first direction of the octagonal metal cavity. A pair of optical inlets are provided in a second direction of the octagonal metal cavity. The first direction is perpendicular to the second direction. The optical inlet is covered by a window. In the three pairs of optical inlets in the first direction, a collimator and a λ/4 wave plate are provided sequentially along an optical transmission direction of each optical inlet. The imaging light for acquiring the atoms in acquiring atomic samples in Bose-Einstein condensate has a wavelength of 589 nm, and an optical power of about 30 μW. The imaging light is expanded through the collimator into parallel light having a diameter of 8 mm, and then formed into circularly polarized light through the λ/4 wave plate. The resonant imaging light is irradiated onto the atomic cloud, and absorbed by the atoms.

In another optional implementation, the image processing apparatus further includes a titanium sublimation pump and an ionic pump. Both the titanium sublimation pump and the ionic pump are configured to keep a vacuum environment of the science cavity.

In an exemplary embodiment, with localization on an atomic cloud of Na atoms as an example, based on the specific structure of the image processing apparatus provided by the present disclosure, detailed descriptions are made on the realization process and effectiveness of the image processing method provided by the present disclosure.

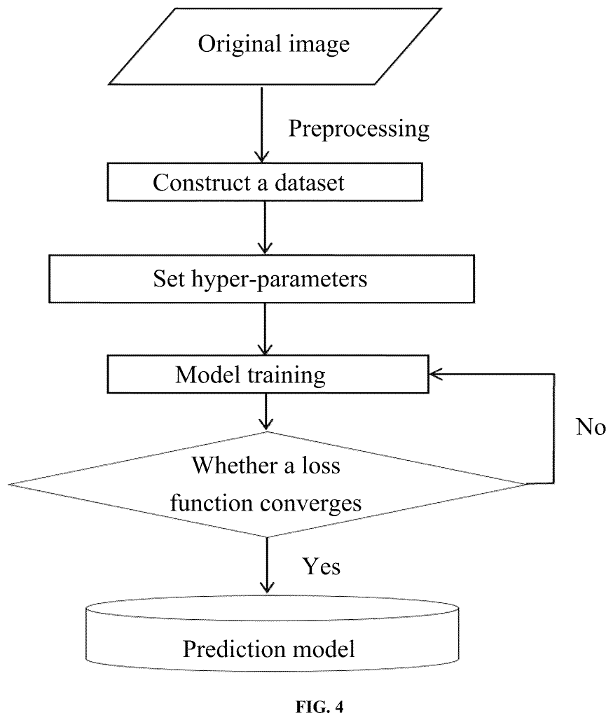

First of all, about 800 images with a pixel resolution of 1292*964 are acquired with the science cavity. These images are divided into three groups: The first image is used for displaying an intensity distribution of the atomic cloud under irradiation of probe light, the second image is an image captured by an image pick-up device (such as a CCD camera) when there is only the probe light without the atoms; and the third image is used for displaying a background intensity when there is neither the probe light nor the atoms. The images in three processes are independent and gray, such that positions of the atoms are hardly distinguished by naked eyes. The three images are overlapped to form a color picture, thereby making the positions of the atoms more visualized. This is crucial to label the region of the atomic cloud subsequently. A regional location of the atomic cloud is labeled with a central coordinate and a size of a rectangle. The region of the atomic cloud is labeled by manually drawing the rectangle, and is taken as a training set of the YOLOv5s model. Before training, the 800 images with a region of the Na atomic cloud labeled manually are divided into the training set and a validation set. The training set is configured to realize model development, while the validation set is configured to evaluate model performance and adjust hyper-parameters. In the training solution, a stochastic gradient descent (SGD) optimizer is used, and a learning rate and a batch size are selected carefully. In the whole training stage, a value of the loss function is monitored continuously, and early stopping is used to prevent overfitting. When performance of the validation set is not improved in several continuous periods, the training is stopped. The specific training process is shown in FIG. 4.

According to preliminary training, the error loss function of the deep network tends to converge after about 200 iterations. Hence, the maximum training number of iterations is 300. In order to validate the accuracy of the evaluated result, 300 images acquired again and not belonging to the training set are taken as a test set.

Physical information on the region of the atomic cloud, such as a total number of atoms, is derived with two-dimensional (2D) Gaussian fitting. In the embodiment, the region of the atomic cloud is defined by the shape of the rectangle. Although the YOLOv5s model can effectively detects the region, and provide the coordinate and size of the corresponding rectangle, the rectangle does not always represent a best region for analysis. The rectangle generated by the YOLOv5s through direct fitting may not generate the most accurate result. Hence, the present disclosure refines the position of the atomic cloud with grid search, and uses the goodness-of-fit as a basis to determine the best region. In the grid search, with a central point of the predicted rectangular box as a reference, and a length of a long side of the rectangular box as a grid size, a square grid is constructed. The search is performed in a range of 60% to 150% of the long side, and at a stride of two pixels. The Gaussian fitting is performed on each grid to compute a goodness-of-fit. An atomic parameter corresponding to a grid having a highest goodness-of-fit is selected as a final fitting result. This method ensures that the most accurate and most representative atomic parameter is obtained from the analysis.

In order to validate the effectiveness of the method, the RF coil is used to couple two magnetic levels mf=−1 and mf=0 of the Na atoms F=1, and experimental data of Rabi oscillation in the two-level system is acquired. In this process, a bias magnetic field is used to split the level F=1, and then an RF pulse is applied. The Stern-Gerlach magnetic field is used to effectively separate different spin components of the atoms, such that the Rabi oscillation between two levels can be observed by measuring time of flight (TOF). F represents a quantum number in the hyperfine structure of the atom.

Compared with the conventional method, the present disclosure has advantages of the automatic batch processing capability and the higher accuracy, is successfully applied to images in Rabi oscillation between Zeenam levels of ultracold atoms, and indicates the potential of the method for calibrating and processing information of the atomic cloud based on the absorption imaging. The method simplifies the data processing flow, ensures the high accuracy, and is promising to become an effective research tool in the field of ultracold atoms.

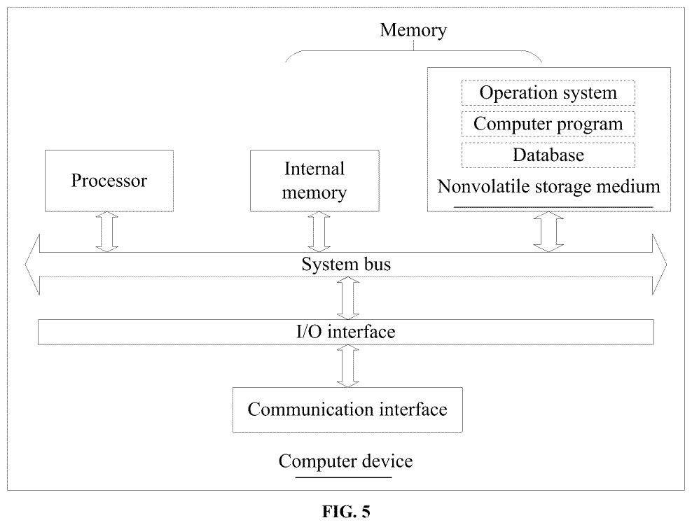

In an exemplary embodiment, a computer device is provided. The computer device may be a server or a terminal, and an internal structure thereof may be as shown in FIG. 5. The computer device includes a processor, a memory, an input/output (I/O) interface, and a communication interface. The processor, the memory and the I/O interface are connected through a system bus. The communication interface is connected to the system bus through the I/O interface. The processor of the computer device is configured to provide computing and control capabilities. The memory of the computer device includes a nonvolatile storage medium and an internal memory. The non-volatile storage medium stores an operating system, a computer program, and a database. The internal memory provides an environment for operation of the operating system and the computer program in the nonvolatile storage medium. The database of the computer device is configured to store an experimental image. The I/O interface of the computer device is configured to exchange information between the processor and an external device. The communication interface of the computer device is configured to communicate with an external terminal through a network. The computer program is executed by the processor to realize the image processing method.

Those skilled in the art may understand that the structure shown in FIG. 5 is only a block diagram of a part of the structure related to the solution of the present disclosure and does not constitute a limitation on the computer device to which the solution of the present disclosure is applied. Specifically, the computer device may include more or less components than those shown in the figure, or combine some components, or have different component arrangements.

In an exemplary embodiment, a computer device is provided, including a memory and a processor. The memory stores a computer program. The computer program is executed by the processor to realize steps of the above method embodiment.

In an exemplary embodiment, a computer-readable storage medium is provided. The computer-readable storage medium stores a computer program. The computer program is executed by a processor to realize steps of the above method embodiment.

In an exemplary embodiment, a computer program product is provided, including a computer program. The computer program is executed by a processor to realize steps of the above method embodiment.

It is to be noted that information of a user (including but not limited to device information of the user, personal information of the user and the like) and data (including but not limited to data for analysis, data for storage, data for exhibition and the like) in the present disclosure are information and data authorized by the user or fully authorized by each party, and relevant data shall be acquired, used and processed according to relevant regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a storage, a database, or other media used in the embodiments of the present disclosure may include at least one of a non-volatile and a volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present disclosure. The description of the foregoing examples is used to help illustrate the method of the present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

While this invention has been particularly shown and described with references to preferred embodiments thereof, it will be understood by those skilled in the art that various changes in form and details may be made therein without departing from the scope of the invention encompassed by the appended claims.

What is claimed is:

1. An image processing method, comprising:
acquiring atomic samples in Bose-Einstein condensate, and obtaining experimental images with absorption imaging;
preprocessing the experimental images to obtain a color picture, the color picture comprising an atomic cloud of the atomic samples;
labeling the color picture to generate a training sample set;
training a YOLOv5s network with the training sample set to obtain a well-trained YOLOv5s network, and taking the well-trained YOLOv5s network as an atomic cloud region localization network;
inputting experimental images of to-be-tested atoms to the atomic cloud region localization network to obtain an atomic cloud region localization result of the to-be-tested atoms; and
refining the atomic cloud region localization result with grid search, performing Gaussian fitting on each grid to obtain a goodness-of-fit, and selecting an atomic parameter corresponding to a grid having a highest goodness-of-fit as a final fitting result.

2. The image processing method according to claim 1, wherein the acquiring atomic samples in Bose-Einstein condensate, and obtaining experimental images with absorption imaging specifically comprises:
in a process of acquiring the atomic samples in Bose-Einstein condensate, performing imaging for three times according to a principle of the absorption imaging to obtain a first image, a second image, and a third image, and taking the first image, the second image, and the third image as the experimental images, wherein the first image is used for displaying an intensity distribution of the atomic cloud under irradiation of probe light, the second image is an image captured when there is only the probe light without atoms; and the third image is used for displaying a background intensity when there is neither the probe light nor the atoms.

3. The image processing method according to claim 2, wherein the preprocessing the experimental images to obtain a color picture specifically comprises:
overlapping the first image, the second image, and the third image to obtain an initial color picture;
determining optical densities of the atomic samples in three imaging processes, and performing thresholding and normalization on the optical densities to obtain the atomic cloud; and
displaying the atomic cloud correspondingly in the initial color picture to obtain the color picture.

4. The image processing method according to claim 1, wherein the labeling the color picture to generate a training sample set specifically comprises:
labeling a regional location of the atomic cloud in the color picture with a rectangular region to obtain labeled sample data; and
generating the training sample set based on the labeled sample data.

5. An image processing apparatus, applied to acquire atoms in Bose-Einstein condensate, and comprising: a science cavity, radio-frequency (RF) coils, a charge coupled device (CCD) camera, and a personal computer (PC) terminal, wherein
the science cavity is configured to acquire the atoms in Bose-Einstein condensate; the RF coils are respectively provided at two opposite optical inlets of the science cavity; the RF coil is configured to transmit an RF signal of a specified frequency, so as to control the atoms; the CCD camera is connected to the PC terminal; the CCD camera is configured to acquire experimental images of the atoms; and the PC terminal is configured to realize the image processing method according to claim 1, so as to obtain an atomic cloud region localization result based on the experimental images.

6. The image processing apparatus according to claim 5, wherein a main body of the science cavity is an octagonal metal cavity; three pairs of optical inlets are provided in a first direction of the octagonal metal cavity; a pair of optical inlets are provided in a second direction of the octagonal metal cavity; the first direction is perpendicular to the second direction; the optical inlet is covered by a window; and in the three pairs of optical inlets in the first direction, a collimator and a λ/4 wave plate are provided sequentially along an optical transmission direction of each optical inlet.

7. The image processing apparatus according to claim 5, wherein the image processing apparatus further comprises a titanium sublimation pump and an ionic pump; and both the titanium sublimation pump and the ionic pump are configured to keep a vacuum environment of the science cavity.

8. A computer device, comprising a memory, a processor, and a computer program stored in the memory and executable on the processor, wherein the processor is configured to execute the computer program to realize steps of the image processing method according to claim 1.

9. A non-transitory computer-readable storage medium, wherein the non-transitory computer-readable storage medium stores a computer program, and the computer program is executed by a processor to realize steps of the image processing method according to claim 1.

10. The image processing apparatus according to claim 5, wherein the acquiring atomic samples in Bose-Einstein condensate, and obtaining experimental images with absorption imaging specifically comprises:
in a process of acquiring the atomic samples in Bose-Einstein condensate, performing imaging for three times according to a principle of the absorption imaging to obtain a first image, a second image, and a third image, and taking the first image, the second image, and the third image as the experimental images, wherein the first image is used for displaying an intensity distribution of the atomic cloud under irradiation of probe light, the second image is an image captured when there is only the probe light without atoms; and the third image is used for displaying a background intensity when there is neither the probe light nor the atoms.

11. The image processing apparatus according to claim 10, wherein the preprocessing the experimental images to obtain a color picture specifically comprises:
overlapping the first image, the second image, and the third image to obtain an initial color picture;
determining optical densities of the atomic samples in three imaging processes, and performing thresholding and normalization on the optical densities to obtain the atomic cloud; and
displaying the atomic cloud correspondingly in the initial color picture to obtain the color picture.

12. The image processing apparatus according to claim 5, wherein the labeling the color picture to generate a training sample set specifically comprises:
labeling a regional location of the atomic cloud in the color picture with a rectangular region to obtain labeled sample data; and
generating the training sample set based on the labeled sample data.

13. The computer device according to claim 8, wherein the acquiring atomic samples in Bose-Einstein condensate, and obtaining experimental images with absorption imaging specifically comprises:
in a process of acquiring the atomic samples in Bose-Einstein condensate, performing imaging for three times according to a principle of the absorption imaging to obtain a first image, a second image, and a third image, and taking the first image, the second image, and the third image as the experimental images, wherein the first image is used for displaying an intensity distribution of the atomic cloud under irradiation of probe light, the second image is an image captured when there is only the probe light without atoms; and the third image is used for displaying a background intensity when there is neither the probe light nor the atoms.

14. The computer device according to claim 13, wherein the preprocessing the experimental images to obtain a color picture specifically comprises:
overlapping the first image, the second image, and the third image to obtain an initial color picture;
determining optical densities of the atomic samples in three imaging processes, and performing thresholding and normalization on the optical densities to obtain the atomic cloud; and
displaying the atomic cloud correspondingly in the initial color picture to obtain the color picture.

15. The computer device according to claim 8, wherein the labeling the color picture to generate a training sample set specifically comprises:
labeling a regional location of the atomic cloud in the color picture with a rectangular region to obtain labeled sample data; and
generating the training sample set based on the labeled sample data.

16. The non-transitory computer-readable storage medium according to claim 9, wherein the acquiring atomic samples in Bose-Einstein condensate, and obtaining experimental images with absorption imaging specifically comprises:
in a process of acquiring the atomic samples in Bose-Einstein condensate, performing imaging for three times according to a principle of the absorption imaging to obtain a first image, a second image, and a third image, and taking the first image, the second image, and the third image as the experimental images, wherein the first image is used for displaying an intensity distribution of the atomic cloud under irradiation of probe light, the second image is an image captured when there is only the probe light without atoms; and the third image is used for displaying a background intensity when there is neither the probe light nor the atoms.

17. The non-transitory computer-readable storage medium according to claim 16, wherein the preprocessing the experimental images to obtain a color picture specifically comprises:
overlapping the first image, the second image, and the third image to obtain an initial color picture;
determining optical densities of the atomic samples in three imaging processes, and performing thresholding and normalization on the optical densities to obtain the atomic cloud; and
displaying the atomic cloud correspondingly in the initial color picture to obtain the color picture.

18. The non-transitory computer-readable storage medium according to claim 9, wherein the labeling the color picture to generate a training sample set specifically comprises:
labeling a regional location of the atomic cloud in the color picture with a rectangular region to obtain labeled sample data; and.
